(19) United States
(12) Patent Application Publication
(10) Pub. No.: US 2009/0078852 A1
(43) Pub. Date: Mar. 26, 2009

(54) CHROMINANCE COMPENSATION METHOD AND PANEL LIGHTENING METHOD IN A DISPLAY APPARATUS

(75) Inventors: Chi-Hsiu Lin, Yulin County (TW); Chun-Chien Chiu, Taoyuan County (TW); Shin-Chang Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/099,777

(22) Filed: Apr. 8, 2008

(30) Foreign Application Priority Data
Sep. 20, 2007 (TW) 96135148

(51) Int. Cl. G01J 1/32

(52) U.S. Cl. 250/205

(57) ABSTRACT

An area-control based LED backlight system for a panel is divided into a plurality of independently controllable light emitting regions. A single color sensor or light sensor detects light emitting status of the regions. Reference values corresponding to the regions are set based on a white balance parameter. The reference values are compared to the light emitting status of the regions for performing color components ratio calibration, so as to compensate luminance and chrominance of light emitted from the regions and lightening the panel. Further, a single light sensor is used for detecting light emitted from LED sets of a whole-panel based LED backlight system for a panel. A reference value is compared to a detection result of the light sensor for generating a color component calibration parameter, so as to compensate luminance and chrominance of light emitted from the LED sets and lightening the panel.

### CROSS-REFERENCE TO RELATED APPLICATION

This application claims the priority benefit of Taiwan application serial no. 96135148, filed on Sep. 20, 2007. The entirety the above-mentioned patent application is hereby incorporated by reference herein and made a part of specification.

### BACKGROUND OF THE INVENTION

1. Field of the Invention

The present invention relates to a chrominance compensation method, a light source driving method and a panel lightening method for a display apparatus.

2. Description of Related Art

Panel display apparatus becomes popular recently due to the advantages of low radiation, smaller size and light weight etc. Light-emitting diodes (LEDs) may be applied in the panel display apparatus to function as a backlight source.

Color sensors and light sensors are used for real-time detecting and feedback compensating of luminance and chrominance of the LED backlight source. Color sensors may detect three colors R/G/B of light, while light sensors may only detect monochromatic light, in which a cost of the color sensors is higher than that of the light sensors.

LED backlight systems may be classified as whole-panel based LED backlight systems, and non-whole-based LED backlight systems, i.e. area-control based LED backlight systems. In the whole-panel based LED backlight system, the LEDs within the system are luminous all the time. The area-control based LED backlight system is divided into a plurality of light emitting regions, and light emitting status of each of the regions are independently controllable.

However, the disadvantages of the whole-panel based LED backlight system are as follows. (1) The greater the panel size is, the higher the power consumption of the backlight source is; (2) when an image with low gray level is displayed, light leakage is relatively obvious, which may cause a degrade of dynamic contrast.

In the area-control based LED backlight system, light emitting of each of the light emitting regions is independently controllable. Therefore, the power consumption may be reduced and the dynamic contrast may be greatly improved.

However, in the whole-panel based LED backlight system and the area-control based LED backlight system, factors such as thermal influence, LED life cycle and light emitting uniformity are all taken into consideration, and therefore the color sensor and the light sensor are required for detecting and feedback compensating of the chrominance of the backlight system. However, since each LED or each light emitting region of the backlight system has different utilization rates, the thermal influence, the LED life cycle and the light emitting uniformity of each LED or each light emitting region may be all different.

Further, for each of the LEDs or for the light sources of respective light emitting regions, independent chrominance detection and feedback compensation are not easy in the state of the art. Therefore, a chrominance and luminance detection and compensation method is required for the whole-panel based LED backlight system and the area-control based LED backlight system, by which color components ratio and the luminance may be independently adjusted.

Further, if lost-cost light sensors are applied in chrominance detection and feedback compensation of the backlight system, fabrication cost may be reduced while similar effect may be achieved.

### SUMMARY OF THE INVENTION

Accordingly, the present invention is directed to a light source chrominance compensation method, a light source driving method and a panel lightening method, by which color components ratio and luminance may be calibrated.

In a detection and compensation method of chrominance and luminance for a light source of a display apparatus according to an embodiment of the present invention, an area-control based LED backlight system is divided into a plurality of independently controllable light emitting regions. A color sensor may be used for detecting a light emitting status of each of the regions, and a detection result is converted into a digital format. Reference values are then compared to the converted detection result to generate a color component calibration parameter for compensating luminance and chrominance of light emitted from the regions. Further, if the area-control based LED backlight system is divided into a plurality of independent subsystems, each of the subsystems may include a plurality of the independently controllable light emitting regions. Each of the subsystems may perform detection and compensation of chrominance and luminance for the light sources according to the aforementioned method.

In a detection and compensation method of chrominance and luminance for a light source of a display apparatus according to another embodiment of the present invention, an area-control based LED backlight system is divided into a plurality of independently controllable light emitting regions. A light sensor may be used for detecting a light emitting status of each of the regions, and a detection result is converted into a digital format. Reference values are then compared to the converted detection result to generate a color component calibration parameter for compensating luminance and chrominance of light emitted from the regions. Further, if the area-control based LED backlight system is divided into a plurality of independent subsystems, each of the subsystems may include a plurality of the independently controllable light emitting regions. Each of the subsystems may perform detection and compensation of chrominance and luminance for the light sources according to the aforementioned method.

In a detection and compensation method of chrominance and luminance for a light source according to yet another embodiment of the present invention, a light sensor is used for detecting light emitting status of LED sets of a whole-panel based LED backlight system, an analog to digital converter is used for converting a detection result of the light sensor, and reference values are then compared to the converted detection result for generating a color component calibration parameter, so as to compensate luminance and chrominance of light emitted from the LED sets. Further, if the whole-panel based LED backlight system is divided into a plurality of independent subsystems, each of the subsystems may include a plurality of the LED sets. Each of the subsystems may perform detection and compensation of chrominance and luminance for the light sources according to the aforementioned method.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a diagram illustrating application of a color sensor for color sensing in an area-control based LED backlight system according to the first embodiment of the present invention.

FIG. 2 is a flowchart illustrating a chrominance detection and feedback compensation method according to the first embodiment of the present invention.

FIG. 3 is a diagram illustrating an application of the first embodiment to a large size panel.

FIG. 4 is a schematic diagram illustrating application of a single light sensor for detecting in a whole-panel based LED backlight system according to the second embodiment of the present invention.

FIG. 5 is a diagram illustrating an application of the second embodiment to a large size panel.

FIG. 6 is a schematic diagram illustrating application of a single light sensor for detecting an area-control based LED backlight system according to the third embodiment of the present invention.

FIG. 7 is a diagram illustrating an application of the third embodiment to a large size panel.

### DESCRIPTION OF EMBODIMENTS

### First Embodiment

In the first embodiment of the present invention, a single color sensor is used for chrominance detection and feedback compensation for a light source of an area-control based LED backlight system. The area-control based LED backlight system may be divided into a plurality of light emitting regions including one LED set (comprising red LED, blue LED and green LED) or a plurality of LED sets.

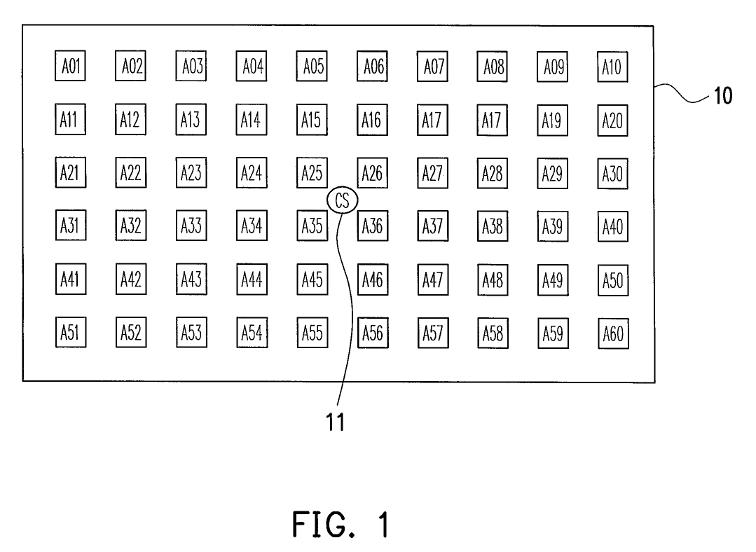

FIG. 1 is a diagram illustrating a relative position between a single color sensor and light emitting regions in the area-control based LED backlight system according to the first embodiment of the present invention. Referring to FIG. 1, the area-control based LED backlight system 10 may be divided into a plurality of light emitting regions A01˜A60. Arrangement of the light emitting regions A01˜A60 is shown as FIG. 1, though the arrangement of the light emitting regions A01˜A60 is not limited thereof.

The color sensor 11 may be disposed in the middle of the area-control based LED backlight system 10. As shown in FIG. 1, no matter where the color sensor 11 is disposed, distances between the color sensor 11 and the light emitting regions A01-A60 are definitely different. Therefore, in the present embodiment, measuring errors occurred due to the different distances may be compensated.

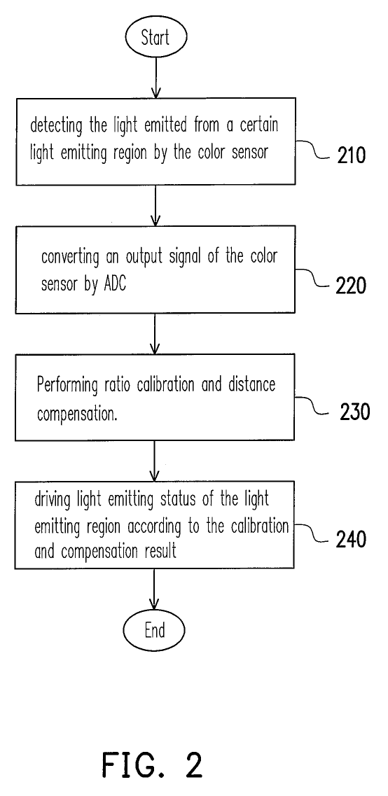

FIG. 2 is a flowchart illustrating a chrominance detection and feedback compensation method according to the first embodiment of the present invention. Referring to FIG. 2, in step 210, the color sensor is used for detecting a RGB light emitted from a certain light emitting region of the area-control based LED backlight system. Namely, the color sensor detects a ratio (i.e. the chrominance) and the luminance of actual RGB color components of light emitted from the light emitting region. As shown in FIG. 1, 60 light emitting data may be obtained.

Next, in step 220, an analog to digital converter (ADC) may convert an output signal of the color sensor. Conversion of the output signal of the color sensor from an analog signal to a digital signal may facilitate operations of the subsequent steps.

Next, in step 230, the detected data is then compared to a reference value for performing color component ratio calibration and distance compensation. The step 230 is to ensure an actual R/G/B ratio of light from the light emitting region to be identical to an ideal R/G/B ratio. This is because the color sensor has different sensitivities for the R/G/B color components.

The reference values corresponding to the light emitting regions may be different with each other. The following factors are taken into consideration for setting the reference values, for example but not limited by, (1) white balance parameter, and (2) distance error. Since the distances between the color sensor and each of the light emitting regions are different, measuring errors of luminance occurred due to distance differences have to be taken into consideration.

The corresponding compensation value of each light emitting region is calculated as follows. A light emitting region A25 is assumed to be a referential light emitting region. A luminance compensation value Ln of each of the light emitting regions is then calculated as follows:

Ln=LiuW_{—}A25/LiuW_{—}An (1)

Wherein n is a referential number of each of the light emitting regions (n=1, 2, 3, 4, . . . 60). LiuW_A25 represents a highest luminance value of the referential light emitting region A25. LiuW_An represents the highest luminance value of a n-th light emitting region.

If the distance differences between the color sensor and each of the light emitting regions may influence the RGB ratio, compensation may also be performed thereon. The compensation values R_An, G_An and B_An corresponding to the R/G/B of each of the light emitting regions are as follows.

R_{—}An=LiuR_{—}A25/LiuR_{—}An (2)

G_{—}An=LiuG_{—}A25/LiuG_{—}An (3)

B_{—}An=LiuB_{—}A25/LiuB_{—}An (4)

Wherein LiuR_A25: a highest red luminance value of the referential light emitting region, LiuG_A25: a highest green luminance value of the referential light emitting region, LiuB_A25: a highest blue luminance value of the referential light emitting region, LiuR_An: a highest red luminance value of the n-th light emitting region, LiuG_An: a highest green luminance value of the n-th light emitting region, and LiuB_An: a highest blue luminance value of the n-th light emitting region.

Next, a light emitting status of each light emitting regions are then driven/calibrated according to the obtained color component calibration parameters and the distance compensation values. For example, when a driving circuit (not shown) drives the light emitting regions in a pulse width modulation (PWM) mode, a PWM signal corresponding to R/G/B may be adjusted according to the color component calibration parameter and the distance compensation value, so as to adjust the light emitting statuses of the red LED, the green LED and the blue LED.

The process flow of FIG. 2 may be applied when the system is started or normally operated. If the process flow is applied when the system is started, the light emitting regions of the system are all turned off at first and then the light emitting regions are sequentially turned on and turned off. Therefore, the color sensor may detect a plurality of data, and each data represents a light emitting status of each light emitting region.

If the process flow is applied when the system is normally operated, the light emitting regions then may be arranged in a sequence (for example, a sequence shown as the referential numbers of FIG. 1). Next, chrominance detection and compensation of the light emitting regions are then performed according to the arranged sequence.

Moreover, in the present embodiment, each time when the color component calibration parameter and the compensation value corresponding to a certain light emitting region are obtained, chrominance compensation of the light emitting region is then performed. Alternatively, after the color component calibration parameters and the compensation values of all the light emitting regions are obtained and stored in a memory, chrominance compensations of all the light emitting regions are then performed.

In addition, the arrangement of the LED light emitting regions may be varied according to an actual requirement, which is not limited to the arrangement method shown in FIG. 1. Driving mode of the LED light emitting regions may also be varied, which is not limited to the PWM mode.

Furthermore, as the panel becomes larger in size, the present embodiment may be modified accordingly. For example, the backlight system applied for illuminating a 100 inches panel may be divided into two or more independent subsystems. Each of the subsystems may achieve the chrominance detection and the feedback compensation for the light emitting regions according to the aforementioned method.

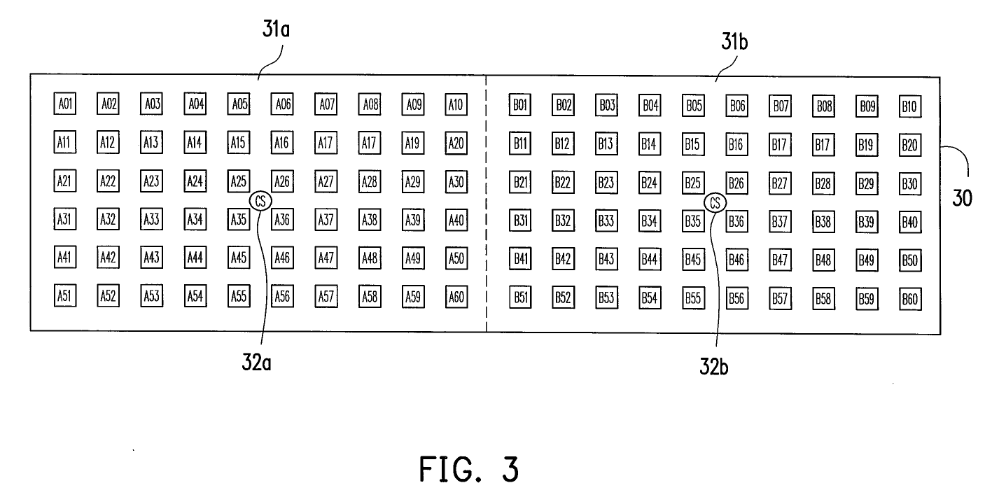

FIG. 3 is a diagram illustrating an application of the first embodiment to a large size panel. Referring to FIG. 3, a system 30 may be divided into a plurality of independent subsystems 31a and 31b, and each of the subsystems may be divided into a plurality of light emitting regions. For example, the independent subsystems 31a and 31b are respectively divided into light emitting regions A01˜A60 and B01˜B60. The independent subsystems 31a and 31b may respectively use a color sensor 32a and a color sensor 32b for detecting the light luminance and chrominance. Operation of the example of FIG. 3 is similar to the aforementioned description, and therefore the detailed description thereof will not be repeated.

In summary, the advantages of the first embodiment are as follows.

(1) Low cost: only minimal number of color sensors or even only one color sensor is required for performing chrominance detection and feedback compensation of the whole system.

(2) Thermal influence to the LED chrominance may be mitigated, since the light emitting statuses of the light emitting regions may be independently adjusted.

(3) Life cycle influence to the LED chrominance may be mitigated, since the light emitting statuses of the light emitting regions may be independently adjusted.

(4) Light emitting uniformity may be improved, since the light emitting statues of the light emitting regions may be independently adjusted.

(5) Competitiveness and advantages of the area-control based LED backlight system may be greatly improved, and particularly a feature of super high dynamic contrast is still remained.

### Second Embodiment

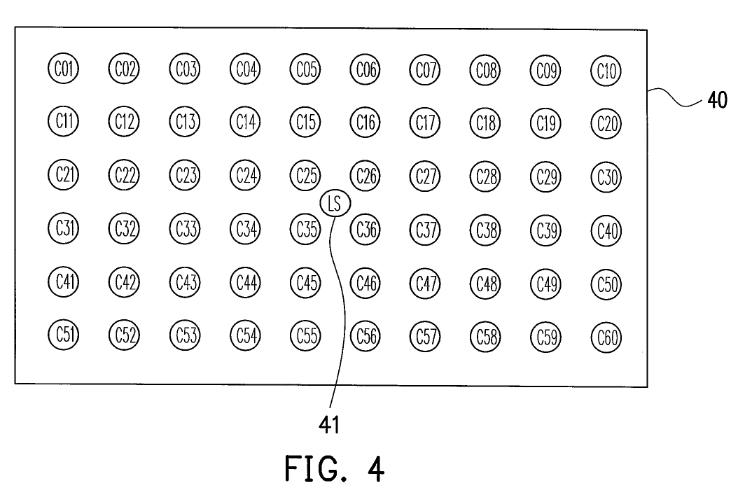

In the second embodiment of the present invention, a single light sensor is used for chrominance detection and feedback compensation of a whole-panel based LED backlight system. FIG. 4 is a schematic diagram illustrating a whole-panel based LED backlight system according to the second embodiment of the present invention.

Referring to FIG. 4, a whole-panel based LED backlight system 40 includes a plurality of LED sets C01˜C60, in which each LED set includes three LEDs, namely, the R/G/B LEDs. However, arrangement of the LED sets C01˜C60 is not limited thereof. The light sensor 41 may be disposed in the middle of the whole-panel based LED backlight system 40.

When the detection is performed, each time only the LEDs of the same color are turned on. Namely, only the light sources of the same color are turned on at the same time. For example, first, all the red LEDs are turned on, and after information of red luminance is obtained, all the red LEDs are turned off and all the green LEDs are turned on. Next, after the information of green luminance is obtained, all the green LEDs are turned off and all the blue LEDs are turned on. Next, after the information of blue luminance is obtained, all the blue LEDs are turned off. Therefore, three data may be detected by the light sensor, and each data represents the light emitting status of all the same color LEDs.

An analog to digital converter may convert an output signal of the light sensor. Next, a reference value is compared to the converted detection result for calibrating the ratio of color components. The reference values respectively corresponding to R/G/B may be different with each other. A RGB white balance parameter is taken into consideration for setting the reference values. All LED sets may be compensated according to the respectively reference values.

Next, the light emitting status of all the same color LEDs are then driven/calibrated according to the obtained color component calibration parameters. The driving/calibrating method is similar to that in the first embodiment, the detailed description thereof will not be repeated.

The aforementioned process flow may be applied when the system is started or normally operated. If the process flow is applied when the system is started, all the LEDs of the system are turned off at first, and then the LEDs are sequentially turned on as above described. Therefore, the light sensor may detect three data, and each data represents light emitting status of all the same color LEDs.

If the process flow is applied when the system is normally operated, the LEDs then may be arranged in a sequence (for example, R/G/B sequence). Next, chrominance detection and compensation of the LED sets may be performed according to the arranged sequence.

Moreover, in the present embodiment, each time when the color component calibration parameter and the compensation value corresponding to the same color LEDs are obtained, chrominance compensation of the LEDs with the same color is then performed. Or after the color component calibration parameters and the compensation values of all the LEDs are obtained and stored in a memory, chrominance compensations of all the LEDs are then performed.

In addition, the arrangement of the LED sets may be varied according to an actual requirement, which is not limited to the arrangement method shown in FIG. 4. Driving mode of the LED sets may also be varied, which is not limited to the PWM mode.

Furthermore, as the panel becomes larger in size, the present embodiment may be modified accordingly. For example, the backlight system for illuminating a 100 inches panel may be divided into two or more independent subsystems. Each of the subsystems may achieve the chrominance detection and the feedback compensation for the light sources according to the aforementioned method.

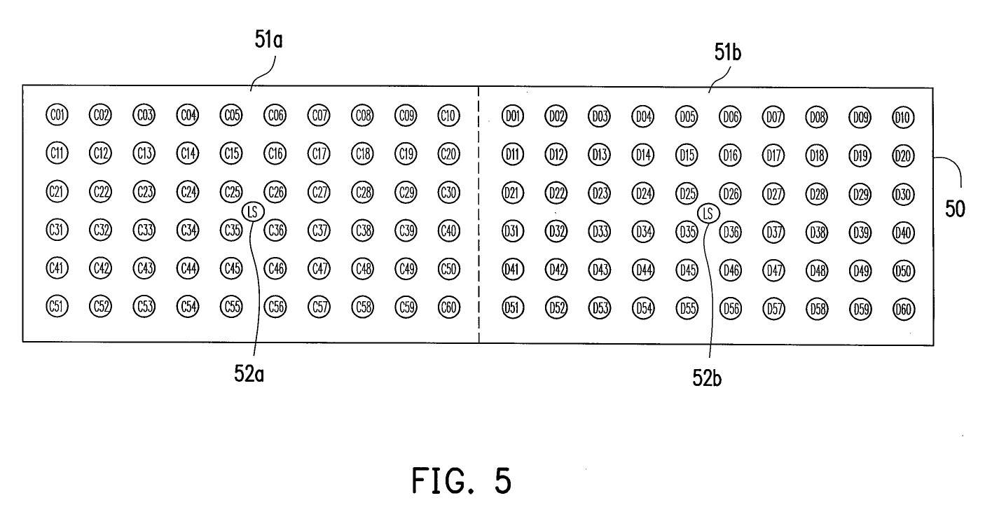

FIG. 5 is a diagram illustrating an application of the second embodiment to a large size panel. Referring to FIG. 5, a large-size system 50 may be divided into a plurality of independent subsystems 51a and 51b, and each of the independent subsystems may include a plurality of LED sets. For example, the independent subsystems 51a and 51b may respectively include the LED sets C01˜C60 and D01˜D60. The independent subsystems 51a and 51b may respectively use a light sensor 52a and a light sensor 52b for detecting the light luminance and chrominance. Operation of the example of FIG. 5 is similar to the aforementioned description, and therefore the detailed description thereof will not be repeated.

In summary, the advantages of the second embodiment are as follows.

(1) Low cost: only minimal number of light sensors or even only one light sensor is required for performing chrominance detection and feedback compensation of the whole system.

(2) Thermal influence to the LED chrominance may be mitigated, since the light emitting status of the LEDs with different colors may be independently adjusted.

(3) Life cycle influence to the LED chrominance may be mitigated, since the light emitting statuses of the LEDs with different colors may be independently adjusted.

(4) Light emitting uniformity may be improved, since the light emitting statuses of the LEDs with different colors may be independently adjusted.

### Third Embodiment

In the third embodiment of the present invention, a single light sensor is used for light source chrominance detection and feedback compensation of an area-control based LED backlight system. The area-control based LED backlight system may be divided into a plurality of light emitting regions including one LED set (comprising red LED, blue LED and green LED) or a plurality of LED sets.

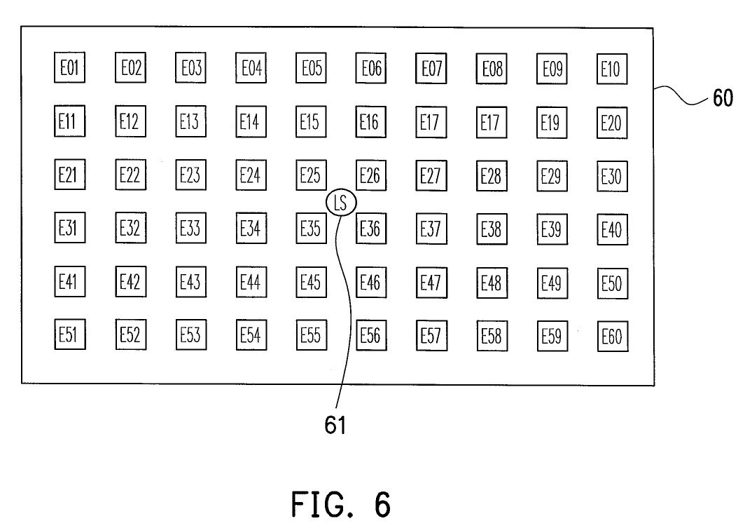

FIG. 6 is a diagram illustrating a relative position between a light sensor and light emitting regions of an area-control based LED backlight system according to the third embodiment of the present invention. Referring to FIG. 6, an area-control based LED backlight system 60 may be divided into a plurality of light emitting regions E01˜E60. Certainly, the arrangement of the light emitting regions E01˜E60 is not limited to that shown as FIG. 6.

The light sensor 61 may be disposed in the middle of the area-control based LED backlight system 60. As shown in FIG. 6, no matter where the light sensor 61 is disposed, distances between the light sensor 61 and the light emitting regions are different. Therefore, in the present embodiment, measuring errors occurred due to the distance differences may be compensated.

A monochromatic light emitted from a certain light emitting region of the area-control based LED backlight system may be detected by the light sensor. For example, all the light emitting regions are first turned off, and the LEDs within a certain light emitting region (for example E01) are then sequentially turned on (for example, in a sequence of R→G→B), so as to obtain the light emitting data thereof. In the embodiment of FIG. 6, 60*3=180 light emitting data may be obtained.

An analog to digital converter may convert an output signal of the light sensor. Next, a reference value is compared to the detected light emitting data for performing the color component ratio calibration and the distance compensation.

The reference values corresponding to each of the light emitting regions may be different with each other. The following factors are taken into consideration for setting the reference values: (1) a RGB white balance parameter, and (2) a distance error. Setting of the reference values may be deduced by analogy according to the aforementioned related description, the detailed description thereof will not be repeated.

Next, the light emitting statuses of the light emitting regions are then driven/calibrated according to the obtained ratio calibration parameters and distance compensation values. The driving/calibrating method is similar to that in the aforementioned embodiment, the detailed description thereof will not be repeated.

The aforementioned process flow may be applied when the system is started or normally operated. If the process flow is applied when the system is started, all the light emitting regions of the system are turned off at first, and then the LEDs of the light emitting regions are sequentially turned on. Therefore, the light sensor may detect a plurality of data, and each data represents a light emitting status of one LED of each light emitting region.

If the process flow is applied when the system is normally operated, all the light emitting regions then may be arranged in a sequence (for example, a sequence shown as the referential numbers of FIG. 6), and the LEDs may also be arranged in a sequence (for example, in a RIG/B sequence). Next, chrominance detection and compensation of the light emitting regions may be performed according to the arranged sequence.

Moreover, in the present embodiment, each time when the color component calibration parameter and the compensation value corresponding to one LED of a certain light emitting region are obtained, chrominance compensation of the one LED of the light emitting region is then performed. Alternatively, after the color component calibration parameters and the compensation values of all the LEDs of the light emitting regions are obtained and stored in a memory, chrominance compensations of all the LEDs of the light emitting regions are then performed.

In addition, the arrangement of the LED light emitting regions may be varied according to an actual requirement, which is not limited to the arrangement shown in FIG. 6. Driving mode of the LED light emitting regions may also be varied, which is not limited to the PWM mode.

Furthermore, as the panel becomes larger in size, the present embodiment may be modified accordingly. For example, the backlight system for illuminating a 100 inches panel may be divided into two or more independent subsystems. Each of the subsystems may achieve the chrominance detection and the feedback compensation for the light emitting regions according to the aforementioned method.

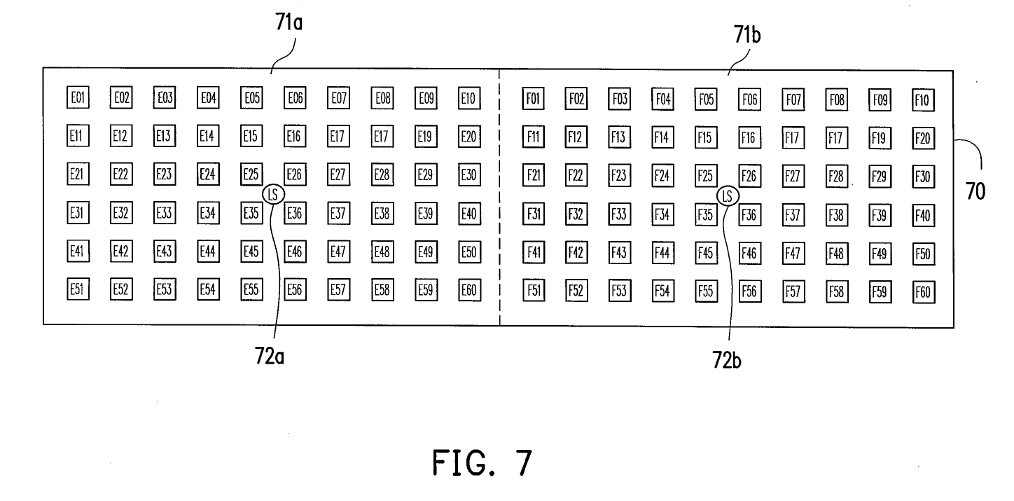

FIG. 7 is a diagram illustrating an application of the third embodiment to a large size panel. Referring to FIG. 7, a large size system 70 may be divided into a plurality of independent subsystems 71a and 71b, and each of the subsystems may be divided into a plurality of light emitting regions. For example, the independent subsystems 71a and 71b may be respectively divided into the light emitting regions E01˜E60 and F01˜F60. The independent subsystems 71a and 71b may respectively use a light sensor 72a and a light sensor 72b for detecting the light luminance. Operation of the example of FIG. 7 is similar to the aforementioned description, and therefore the detailed description thereof will not be repeated.

In summary, the advantages of the third embodiment are as follows.

(1) Low cost: only minimal number of light sensors or even only one light sensor is required for performing chrominance detection and feedback compensation of the whole system.

(2) Thermal influence to the LED chrominance may be mitigated, since the light emitting status of the LEDs may be independently adjusted.

(3) Life cycle influence to the LED chrominance may be mitigated, since the light emitting statuses of the LEDs may be independently adjusted.

(4) Light emitting uniformity may be improved, since the light emitting statuses of the LEDs may be independently adjusted.

(5) Competitiveness and advantages of the backlight system may be greatly improved, and particularly a feature of super high dynamic contrast is still remained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A detection and compensation method of chrominance and luminance for a light source, comprising:
providing an area-control based LED backlight system, and dividing the area-control based LED backlight system into a plurality of independently controllable light emitting regions;
providing a color sensor, for detecting light emitting status of the light emitting regions;
providing an analog to digital converter, for converting a detected result of the color sensor; and
comparing a reference value to a converted result of the analog to digital converter to generate a color component calibration parameter, for compensating luminance and chrominance of light emitted from the light emitting regions.

2. The detection and compensation method of chrominance and luminance for a light source as claimed in claim 1, wherein generating of the color component calibration parameter further comprises:
comparing the reference value to the converted result of the analog to digital converter to generate a compensation value, wherein setting of the reference value relates to a white balance value.

3. The detection and compensation method of chrominance and luminance for a light source as claimed in claim 2, wherein setting of the reference value further relates to a distance error parameter.

4. The detection and compensation method of chrominance and luminance for a light source as claimed in claim 3, wherein setting of the distance error parameter comprises:
choosing one of the light emitting regions as a referential light emitting region; and
obtaining luminance compensation values of the other light emitting regions according to the following formula:
Ln=LiuW_{—}Aref/LiuW_{—}An,
wherein Ln represents the luminance compensation values of the other light emitting regions, n is a referential number of each of the light emitting regions, LiuW_Aref represents a highest luminance value of the referential light emitting region, and LiuW_An represents a highest luminance value of a n-th light emitting region.

5. The detection and compensation method of chrominance and luminance for a light source as claimed in claim 3, wherein setting of the distance error parameter comprises:
choosing one of the light emitting regions as a referential light emitting region; and
obtaining red luminance compensation values of the other light emitting regions according to the following formula:
R_{—}An=LiuR_{—}Aref/LiuR_{—}An,
wherein R_An represents the red luminance compensation values of the other light emitting regions, n is a referential number of each of the light emitting regions, LiuR_Aref represents a highest red luminance value of the referential light emitting region, and LiuR_An represents a highest red luminance value of a n-th light emitting region.

6. The detection and compensation method of chrominance and luminance for a light source as claimed in claim 3, wherein setting of the distance error parameter comprises:
choosing one of the light emitting regions as a referential light emitting region; and
obtaining green luminance compensation values of the other light emitting regions according to the following formula:
G_{—}An=LiuG_{—}Aref/LiuG_{—}An,
wherein G_An represents the green luminance compensation values of the other light emitting regions, n is a referential number of each of the light emitting regions, LiuG_Aref represents a highest green luminance value of the referential light emitting region, and LiuG_An represents a highest green luminance value of a n-th light emitting region.

7. The detection and compensation method of chrominance and luminance for a light source as claimed in claim 3, wherein setting of the distance error parameter comprises:
choosing one of the light emitting regions as a referential light emitting region; and
obtaining blue luminance compensation values of the other light emitting regions according to the following formula:
B_{—}An=LiuB_{—}Aref/LiuB_{—}An,
wherein B_An represents the blue luminance compensation values of the other light emitting regions, n is a referential number of each of the light emitting regions, LiuB_Aref represents a highest blue luminance value of the referential light emitting region, and LiuB_An represents a highest blue luminance value of a n-th light emitting region.

8. The detection and compensation method of chrominance and luminance for a light source as claimed in claim 3, wherein compensation of the light emitting regions comprises:
each time when the color component calibration parameter and the compensation value corresponding to each of the light emitting regions are obtained, performing chrominance and luminance compensation of each light emitting region.

9. The detection and compensation method of chrominance and luminance for a light source as claimed in claim 3, wherein compensation of the light emitting regions comprises:
after the color component calibration parameters and the compensation values of all the light emitting regions are obtained and stored, performing chrominance and luminance compensations of all the light emitting regions.

10. A detection and compensation method of chrominance and luminance for a light source, comprising:
providing an area-control based LED backlight system, and dividing the area-control based LED backlight system into a plurality of independently controllable light emitting regions;
providing a light sensor, for detecting light emitting status of the light emitting regions;
providing an analog to digital converter, for converting a detected result of the light sensor; and
comparing a reference value to a converted result of the analog to digital converter to generate a color component calibration parameter for compensating luminance and chrominance of light emitted from the light emitting regions.

11. The detection and compensation method of chrominance and luminance for a light source as claimed in claim 10, wherein generating of the color component calibration parameter further comprises:
comparing the reference value to the converted result of the analog to digital converter to generate a compensation value, wherein setting of the reference value relates to a white balance value.

12. The detection and compensation method of chrominance and luminance for a light source as claimed in claim 11, wherein setting of the reference value further relates to a distance error parameter.

13. The detection and compensation method of chrominance and luminance for a light source as claimed in claim 12, wherein setting of the distance error parameter comprises:
choosing one of the light emitting regions as a referential light emitting region; and
obtaining luminance compensation values of the other light emitting regions according to the following formula:
Ln=LiuW_{—}Aref/LiuW_{—}An,
wherein Ln represents the luminance compensation values of the other light emitting regions, n is a referential number of each of the light emitting regions, LiuW_Aref represents a highest luminance value of the referential light emitting region, and LiuW_An represents a highest luminance value of a n-th light emitting region.

14. The detection and compensation method of chrominance and luminance for a light source as claimed in claim 12, wherein setting of the distance error parameter comprises:
choosing one of the light emitting regions as a referential light emitting region; and
obtaining red luminance compensation values of the other light emitting regions according to the following formula:
R_{—}An=LiuR_{—}Aref/LiuR_{—}An,
wherein R_An represents the red luminance compensation values of the other light emitting regions, n is a referential number of each of the light emitting regions, LiuR_Aref represents a highest red luminance value of the referential light emitting region, and LiuR_An represents a highest red luminance value of a n-th light emitting region.

15. The detection and compensation method of chrominance and luminance for a light source as claimed in claim 12, wherein setting of the distance error parameter comprises:
choosing one of the light emitting regions as a referential light emitting region; and
obtaining green luminance compensation values of the other light emitting regions according to the following formula:
G_{—}An=LiuG_{—}Aref/LiuG_{—}An,
wherein G_An represents the green luminance compensation values of the other light emitting regions, n is a referential number of each of the light emitting regions, LiuG_Aref represents a highest green luminance value of the referential light emitting region, and LiuG_An represents a highest green luminance value of a n-th light emitting region.

16. The detection and compensation method of chrominance and luminance for a light source as claimed in claim 12, wherein setting of the distance error parameter comprises:
choosing one of the light emitting regions as a referential light emitting region; and
obtaining blue luminance compensation values of the other light emitting regions according to the following formula:
B_{—}An=LiuB_{—}Aref/LiuB_{—}An,
wherein B_An represents the blue luminance compensation values of the other light emitting regions, n is a referential number of each of the light emitting regions, LiuB_Aref represents a highest blue luminance value of the referential light emitting region, and LiuB_An represents a highest blue luminance value of a n-th light emitting region.

17. The detection and compensation method of chrominance and luminance for a light source as claimed in claim 12, wherein compensation of the light emitting regions comprises:
each time when the color components calibration parameter and the compensation value corresponding to each of the light emitting regions are obtained, performing chrominance and luminance compensation of each light emitting region.

18. The detection and compensation method of chrominance and luminance for a light source as claimed in claim 12, wherein compensation of the light emitting regions comprises:
after the color components calibration parameters and the compensation values of all the light emitting regions are obtained and stored, performing chrominance and luminance compensations of all the light emitting regions.

19. A detection and compensation method of chrominance and luminance for a light source, comprising:
providing a whole-panel based LED backlight system comprising a plurality of LED sets;
providing a light sensor, for detecting light emitting status of the LED sets;
providing an analog to digital converter, for converting a detected result of the light sensor; and
comparing a reference value to a converted result of the analog to digital converter to generate a color component calibration parameter for compensating luminance and chrominance of light emitted from the LED sets.

20. The detection and compensation method of chrominance and luminance for a light source as claimed in claim 19, wherein setting of the reference value relates to a white balance value.

21. The detection and compensation method of chrominance and luminance for a light source as claimed in claim 19, wherein compensation of the LED sets comprises:
each time when the color component calibration parameter corresponding to each of the LED sets are obtained, performing chrominance and luminance compensation of each LED set.

22. The detection and compensation method of chrominance and luminance for a light source as claimed in claim 19, wherein compensation of the LED sets comprises:
after the color component calibration parameters of all the LED sets are obtained and stored, performing chrominance and luminance compensations of all the LED sets.
